(19) United States
(12) Patent Application Publication
(10) Pub. No.: US 2023/0340774 A1
(43) Pub. Date: Oct. 26, 2023

(54) MODULAR WALL SYSTEM AND TELESCOPIC MEMBERS THEREOF

(71) Applicant: Capped Out Media, Taylorsville, UT (US)

(72) Inventor: Waynard Schmidt, Taylorsville, UT (US)

(73) Assignee: Capped Out Media, Taylorsville, UT (US)

(21) Appl. No.: 17/726,219

(22) Filed: Apr. 21, 2022

(51) Int. Cl. E04B 1/343; A47B 3/00; A47C 15/00; F21V 33/00; F21V 21/22

(52) U.S. Cl. CPC E04B 1/34305; A47B 3/00; A47C 15/004; F21V 33/006; F21V 21/22

(57) ABSTRACT

A modular wall may include one or more units. Each unit may include a telescopic member having an inner end and an outer end. The telescopic member may include a base, located at the inner end; a capital, located at the outer end; and a shaft disposed between the inner end and the outer end. The shaft may include one or more sections. Each shaft section may include an outer circumference, the outer circumference of each shaft section may decrease from the outer end to the inner end.

### FIELD OF INVENTION

The present invention is in the field of configurable furniture. Specifically, convertible modular walls having concealable telescoping members for use as furniture.

### INTRODUCTION

Furniture often occupies a great deal of the floor space in a given room. Moreover, conventional furniture may be heavy or otherwise difficult to move. Accordingly, conventional furniture may inhibit the full use of a particular room.

A potential solution may be to utilize multi-purpose furniture. For example, an individual may purchase a couch capable of converting into a bed. However, since such furniture includes the structural components of both types of furniture, the multi-purpose furniture may be exceedingly heavy and cumbersome. Additionally, multi-purpose furniture may be difficult to move through doorways and may be expensive to ship. Even further, many multi-purpose furniture units may require specialized tools or difficult maneuvers to convert between furniture types. Thus, such furniture units alienate individuals who are not handy or otherwise have poor motor coordination.

Regardless of the number of functions of a particular multi-purpose furniture unit, such a unit obstructs usable space. Therefore, it would be desirable to provide a modular furniture unit configured to occupy minimal space when not in use. It would be further desirable to provide a modular furniture unit that is easily convertible without the use of specialized tools or maneuverers.

It would be yet further desirable to provide a module furniture system integrated with the wall of a preexisting room.

### SUMMARY

In an aspect of this disclosure, a modular wall may include one or more units. Each unit may include a telescopic member having an inner end and an outer end. The telescopic member may include a base, located at the inner end; a capital, located at the outer end; and a shaft disposed between the inner end and the outer end. The shaft may include one or more sections. Each shaft section may include an outer circumference, the outer circumference of each shaft section may decrease from the outer end to the inner end.

In an embodiment, each shaft section may further include a ridge disposed around the outer circumference of each shaft section.

In another embodiment, the capital may include at least one light source. Each light source may be in electrical communication with an apparatus, and the apparatus may be configured to selectively illuminate the at least one light source.

In yet another embodiment, the modular wall may further include a database stored on a machine-readable memory of the apparatus. The database may contain one or more preconfigured lighting arrangements. Upon a selection of a lighting arrangement by a user, the apparatus may illuminate one or more light sources in accordance with the selected lighting arrangement.

In a further embodiment, the capital may be disc-shaped, having a diameter which is greater than a diameter of the outer end of the shaft.

In an embodiment, the capital of the telescopic member may be joined to the capital of at least one adjacent telescopic member.

In another embodiment, the base and the unit may be a unibody construction.

In yet another embodiment, each unit may be configured to be removably attached to other units via one or more grooves or protrusions.

An aspect of the present disclosure may include a modular wall system including one or more units. Each unit may include a telescopic member having an inner end and an outer end. The telescopic member may include a base, located at the inner end; a capital, located at the outer end; and a shaft disposed between the inner end and the outer end. The shaft may include one or more sections. Each shaft section may include an outer circumference, the outer circumference of each shaft section may decrease from the outer end to the inner end. The modular wall system may further include an apparatus. The apparatus may be in electrical communication with each of the at least one light source. The apparatus may be configured to selectively illuminate the at least one light source.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a system based on a computer according to aspects of the present disclosure.

FIG. 2 illustrates a computing machine according to aspects of the present disclosure.

FIG. 3 illustrates an embodiment of a modular wall.

FIG. 4 illustrates an embodiment of a modular wall having a plurality of telescopic members.

FIG. 5 shows a cutaway view of a first configuration of a portion of a telescopic member and unit thereof according to aspects of the present disclosure.

FIG. 6 shows a cutaway view of a second configuration of a portion of a telescopic member and unit thereof according to aspects of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

Circuit elements and diagrams disclosed herein are simplified to articulate the key features of the present disclosure, and such elements and diagrams are sufficient to enable those skilled in the art to practice the disclosure.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

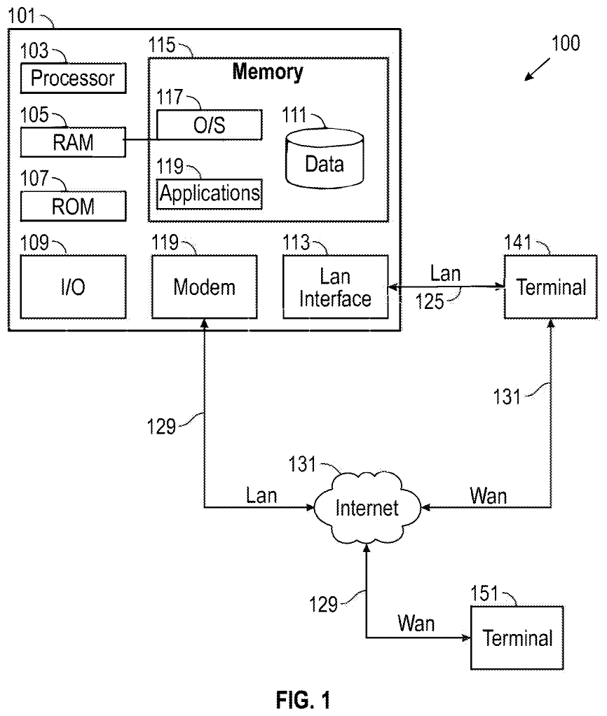

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (“LAN”) 125 and a wide area network (“WAN”) 129, but may also include other networks. When used in a LAN networking environment, computer 101 is connected to LAN 125 through a LAN interface 113 or adapter. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (“SMS”), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

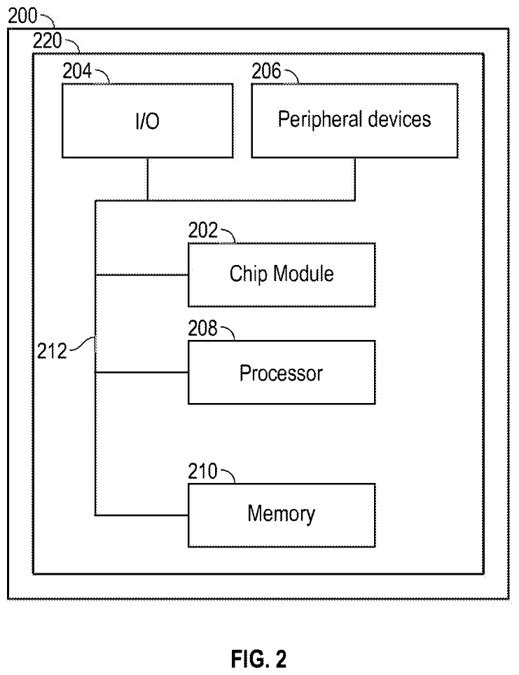

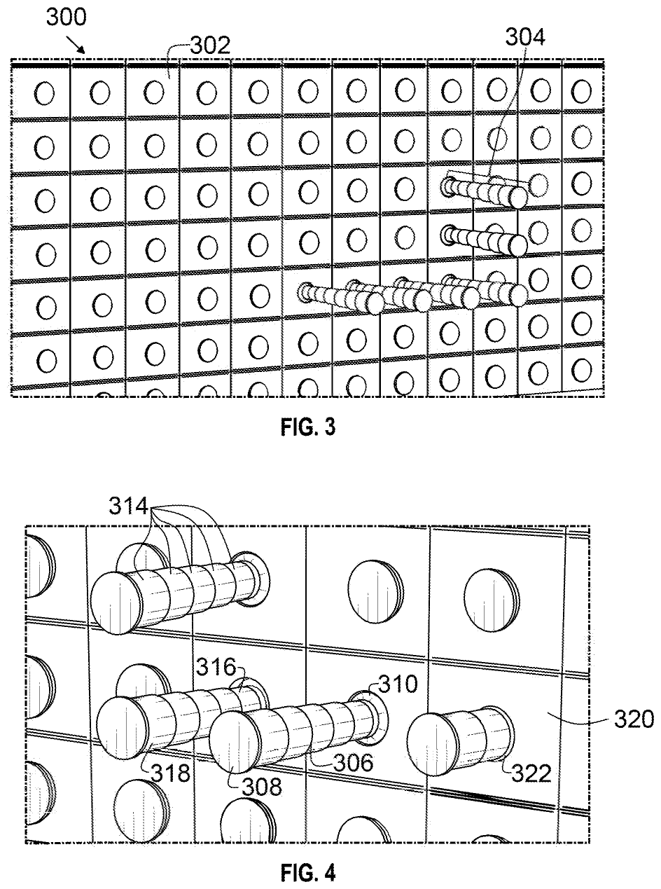

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

The invention of the present disclosure may be a modular wall 300. The modular wall 300 may comprise a plurality of units 302. Each unit 302 may house a telescopic member 304. The units 302 and/or telescopic members 304 may be constructed via additive manufacturing.

In an embodiment, the modular wall 300 may be disposed along or incorporated with a preexisting wall, floor, or ceiling. For example, the modular wall 300 may be disposed against the inside wall of a public space, such as an airport, train station, or bus depot. However, the modular wall 300 may be utilized in conjunction with any suitable receiving surface. In another embodiment, the modular wall 300 may be configured as a freestanding entity. For example, the modular wall 300 may be a rectangular planar member being capable of sturdily standing orthogonal to a floor or other ground surface. Thus, for the purposes of this disclosure, the modular wall 300 may be structurally separable from a pre-existing wall or may be integral to the structure of a building or pre-existing wall thereof.

Each unit 302 may be of uniform dimensions, such that the units 302 may be stacked and disposed adjacently to construct the modular wall 300. In an embodiment, the units 302 may be standalone entities, capable of separating from other units 302 and/or the modular wall 300. However, in another embodiment, the units 302 may be integral to the modular wall 300, such that the units 302 are not easily separable from the modular wall 300. Each unit 302 may include one or more protrusions, or one or more grooves, on one or more faces of the unit 302 such that it may be removably attached to adjacent units 302. Such protrusions and/or grooves may be configured such that protrusions interlock with adjacent grooves. However, any attachment means may be disposed between the units 302 to enable removable and/or fixed attachment. For example, attachment means may include adhesives, magnets, brackets, hinges, and/or fasteners.

In an embodiment, each telescopic member 304 is reversibly configurable between a compressed state and an extended state. In a compressed state, a majority of the telescopic member 304 may be housed within its corresponding unit 302. In an extended state, the majority of the telescopic member 304 may be projecting from the unit 302. In one embodiment, in an extended state, the telescopic member 304 may extend orthogonally from the unit 302 and/or the plane of the modular wall 300.

Each telescopic member 304 may be constructed from one or more of rigid plastic, flexible plastic, solid molded plastic, hollow molded plastic, polyester, polyethylene, polyethylene terephthalate, high density polyethylene, low density polyethylene, polystyrene, high impact polystyrene, polyamides, polyvinyl chloride, polypropylene, polycarbonate, polyurethane, polytetrafluroethylene, rubber, silicone, cardboard, paper, metal, wood, glass, or ceramic. In an embodiment, each telescopic member 304 is constructed from a rigid plastic. However, any suitable material may be used. For example, each telescopic member 304 may be constructed from metals, such as aluminum or steel.

Each telescopic member 304 may comprise a shaft 306, a capital 308, and a base 310. The shaft 306 may be comprised of shaft sections 314, such that the collection of shaft sections 314 enable the shaft 306 to be collapsed and expanded. Additionally, the telescopic member 304 may include an inner end 316 and an outer end 318. The inner end 316 may be the portion of the telescopic member 304 in closest proximity to the unit 302 when the telescopic member 304 is in the extended state. The outer end 318 may be the portion of the telescopic member 304 furthest from the unit 302 when the telescopic member 304 is in the extended state. The capital 308 may be disposed on the outer end 318 of the telescopic member 304. The capital 308 may be a disc-shaped member disposed orthogonal to the shaft 306. Further, the capital 308 may have a diameter greater than the diameter of the outer end 318 of the shaft 306. Thus, the capital 308 may eclipse the shaft 306 when the telescopic member 304 is in the compressed state. For example, the capital 308 may have a greater diameter than the most adjacent shaft section 314 to reduce the likelihood of objects or persons from sliding off the telescopic member 304. In such a non-limiting example, the greater diameter of the capital 308 may act as a retainer for the objects or persons received by the top surface of the telescopic member 304.

The capital 308 of one telescopic shaft 304 may be joined to capitals 308 of other adjacent telescopic shafts 304 such that extending one telescopic shaft 304 may cause all the joined telescopic shafts 304 to uniformly extend. Thus, a preconfigured shape may be achieved by joining together more than one capital 308. For example, a thin rigid member may be disposed between a predetermined arrangement of telescopic shafts 304. Thus, actuation of one or more of the plurality of telescopic shafts 304 may cause the entirety of the predetermined plurality of telescopic shafts 304 to extend or collapse. For example, two horizontally adjacent telescopic shafts 304 may be tethered by a joining member, such that the extension of both horizontally adjacent telescopic members 304 create a larger receiving surface to function as a seat or table.

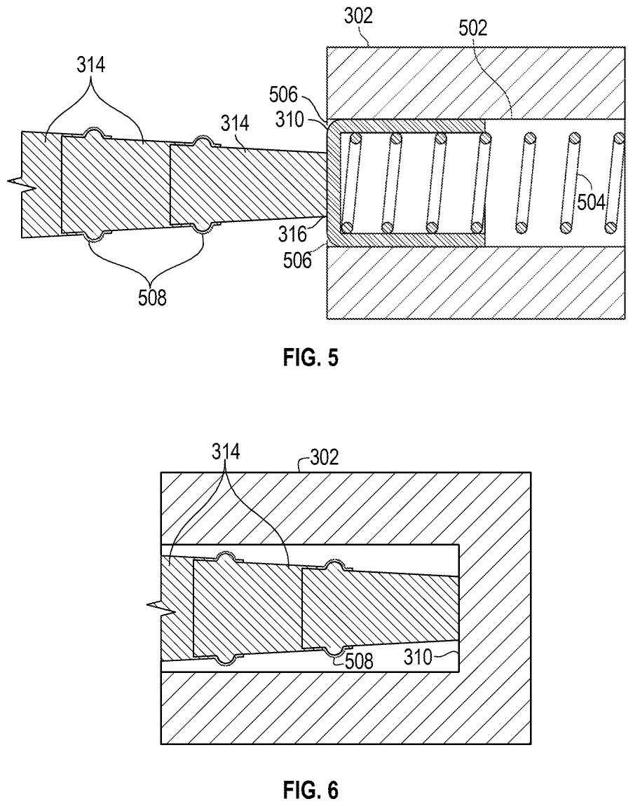

In an embodiment, the base 310 is disposed on the inner end 316 of the telescopic member 304. As shown in FIG. 5, the base 310 may be a cylindrical member which may be attached to the shaft section 314 at the inner end 316 of the shaft 306. In an embodiment, the base 310 moves within a cylinder 502 defined by the unit 302. To adequately support the telescopic member 304 when under load, the base 310 may extend into the cylinder 502 as shown in FIG. 5. A unit aperture 322 may be sized to accept the shaft 306 when the telescopic member 304 is in the compressed state. To allow the base to move through the cylinder between a compressed and extended state, a spring 504 may by housed within the cylinder 502 and base 310. The unit 302 may contain one or more lips 506 to prevent the spring 504 from overextending, causing the base 310 to exit the cylinder 502.

When in a compressed state, the capital 308 may contain one or more magnets, and the unit may contain one or more magnets positioned around the unit aperture 322, such that the capital 308 secures the telescopic member 304 in a compressed state.

As shown in FIG. 6, in an embodiment, the base 310 may be integral to the unit 302 such that the unit 302 and the base 310 are a unibody construction. To allow the shaft 306 of the telescopic member 304 to fully insert into the unit 302, the base 310 may be displaced into an interior of the unit 302.

The shaft 306 may be comprised of a plurality of shaft sections 314. The shaft sections 314 may each be sized to accept one or more shaft sections 314. For example, the outer most shaft sections may be sized to accept the multitude of shaft sections between said outer most shaft section and the base 310. Thus, each succeeding shaft section may be configured to accept those which have come before. For the purposes of this disclosure, “succeeding” may refer to sections that have surpassed inner positioned sections. For example, the outer most shaft section may succeed each shaft section before it.

In an embodiment, each succeeding shaft section may be sized a factor larger than the shaft section immediately before it. Accordingly, the shaft 306 may telescope such that the shaft sections furthest from the base 310 have incrementally greater diameters. Thus, in an extended state, the shaft 306 may taper from the outer end 318 to the inner end 316. In practice, such shaft geometry may coerce items and persons towards the modular wall 300 such that said items and persons are less likely to slip towards or off the outer end 318. In an alternate embodiment, each succeeding shaft section may be sized a factor smaller than the shaft section immediately before it. In such an alternate embodiment, the telescopic member 304 may provide similar structure and functionality, yet may include an “opposite” tapered geometry.

Each of the shaft sections 314 may be conically shaped, such that an outer circumference of each shaft section 314 gradually increases from an inner end 316 of each shaft section 314, to an outer end 318 of each shaft section 314. In such an embodiment, the interface between the inner end 316 of one shaft section 314, and the outer end 318 of an adjacent shaft section 314, prevents the shaft sections 314 from detaching from each other when the shaft 306 is fully extended. For clarity, each shaft section 314 may include a shaft section inner end and a shaft section outer end, wherein the outer circumference of the shaft section inner end is less than that of the shaft section outer end.

Each shaft section 314 may contain a locking mechanism which locks each shaft section 314 in place when the telescopic member 304 is in its fully extended position. The locking mechanism may be a ridge 508 disposed around an outer circumference (for example, the shaft section inner end outer circumference and/or the shaft section outer end outer circumference) of each shaft section 314. The ridge 508 may be configured such that it provides a point of increased resistance when the telescopic member 304 is being extended or collapsed. This function may prevent unwanted movement of each telescopic member 304 when in use. As a non-limiting example, during extension of the telescopic member 304, the telescopic member 304 may reach a length wherein the user may further extend the telescopic member 304, causing the locking mechanism (for example, the ridges 508) to engage. In another non-limiting example, extensions of the telescopic member 304 may automatically cause the locking mechanisms to engage. Further, such locking mechanisms may be unengaged by applying pressure to the telescopic member 304 towards the unit 302 (for example, pressure applied normal to the capital 308).

In a further embodiment, the locking mechanism may be a “twist and lock” mechanism, such that a user may rotate one or more shaft sections 314 to lock said shaft sections 314 to adjacent shaft sections 314. The “twist and lock” mechanism may improve strength and locking of the telescopic member 304. In such an embodiment, the locking mechanisms of each shaft section 314 may be adapted such that rotary motion applied to the outer most shaft section may cause each of the preceding shaft sections to “twist and lock.” For example, a user may apply a clockwise (or other rotation) rotation to the capital 308 or outer most shaft section to lock the remaining shaft sections. Further, in such an example, it would follow that the user may apply an opposite rotation to the same capital 308 or outer most shaft section to unlock each of the remaining shaft sections.

Each unit 302 may include a unit aperture 322 disposed on the unit front face 320. The unit aperture 322 may be an opening sized to at least permit the extension of the telescopic member 304. Further, the unit aperture 322 and the base 310 may be sized such that the base 310 generally fills the unit aperture 322 when the telescopic member 304 is in the extended state.

The telescopic member 304 may convert from a compressed state to an extended state via an initiate pressure sensitive action. In an embodiment, when the telescopic member 304 is in the compressed state, pressure may be applied to the face of the capital 308, causing the telescopic member 304 to retract within the unit 302 a releasing distance. The releasing distance may be a distance sufficient to disengage the locking mechanism holding the telescopic member 304 in the compressed state. Thus, after application of pressure, the telescopic member 304 may protrude from the unit 302 until the telescopic member 304 is in the extended state. In such a conversion from the compressed state to the extended state, succeeding sections 314 may extend past preceding sections 314. The telescopic member 304 may be spring loaded, such that, once released from the locking mechanism, the telescopic member 304 is propelled to the extended state via the spring. In such an embodiment, a spring may reside within the shaft 306 such that the spring is positioned in the direction of compression and/or extension. Thus, spring may include an inner spring end and an outer spring end, wherein the inner spring end is coupled to the base 310 and/or the unit 302 and the outer spring end is coupled to the capital 308 and/or the outer most shaft section.

Each of the shaft sections 314 may have a uniform wall thickness. However, alternatively the thickness of each shaft section 314 may fluctuate in accordance with the taper of each shaft section (for example, the slightly conical nature as described earlier). In a further embodiment, various groups of shaft sections may include different wall thicknesses. For example, a group of shaft sections in close proximity to the unit 302 may have an increased wall thickness as compared to the wall thicknesses of a group of distal shaft sections. Accordingly, shaft sections of various wall thicknesses may be arranged to provide the structural integrity in areas where structural integrity is most crucial (for example, at the joining of the base 310 and the inner most shaft sections).

The telescopic member 304 may convert from a compressed state to an extended state via an electrical motor, or solenoid. In such an embodiment, the mechanism of each telescopic member 304 is in electrical communication with the apparatus 200. A user may store instructions on the memory 210 to automatically extend a certain number of telescopic members 304 depending on the needs of the user.

The capital 308 may include one or more light sources. Each light source may be capable of emitting one or more colors such as red, green, or blue. An apparatus 200 may be in electrical communication with the one or more lights, and configured to illuminate, or not illuminate, one or more capitals 308 and/or units 302. In such an embodiment, a user may store preconfigured lighting arrangements on a database located on the machine-readable memory 210, such that, upon selection of that configuration, the corresponding light sources on one or more capitals 308 illuminates. For example, a user may store a “2-seat” configuration which, when selected, may illuminate the corresponding capitals 308 and/or units 302 of one or more telescopic members 304. These illuminated telescopic members 304 may then be extended to form two chairs. Different configurations may be stored depending on the needs of the user. For example, in addition to the “2-seat” configuration, a user may store configurations for tables or other suitable structures. Light sources may be disposed on the front face of each unit 302, each capital 308, or any other suitable location. Accordingly, the light sources may communicate a selected pattern to the user such that the user may manually extend each of the lighted telescopic members 304.

Succeeding sections 314 and preceding sections 314 may include portions which are concentric for a support distance. The support distance may be a distance measured along the axis of the shaft 306 wherein one section 314 overlaps another section 314. The support distance may be a distance sufficient to induce rigidity in the telescopic member 304. For example, the support distance may be sufficient to allow the telescopic member 304 to receive downward force similar to that of the weight of an average adult, while preventing the sections 314 from detaching from their neighboring sections 314. The support distance may vary depending on the material each section 314 is constructed from. For example, sections 314 made from polyethylene may require a greater support distance than sections made from metal such as steel.

In various embodiments, the shapes of the telescopic members 304 may vary. For example, each of the telescopic members 304 may be generally cylindrical. However, in another embodiment, each telescopic member 304 may comprise a semi-circle cross-section, such that the flat portion faces upward. In such an embodiment, the flat portion of the telescopic member 304 may provide a more comfortable seat for a user.

In a further embodiment, each unit 302 includes an internal safety lock, wherein the corresponding telescopic member 304 may be locked in the extended or compressed state. For example, the apparatus 200 may be configured to lock certain telescopic members in the compressed state relative to other telescopic members in the expanded state. As a non-limiting example, if a user has selected a “2-seat” configuration, the apparatus 200 may lock the telescopic members directly above those members in the “2-seat” configuration. Accordingly, the telescopic members, which would otherwise project into the user in the seated position and potentially injure said user, would be prevented from expanding.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A modular wall, comprising:
one or more units, wherein each unit includes a telescopic member having an inner end and an outer end, the telescopic member including:
a base, located at the inner end;
a capital, located at the outer end; and
a shaft disposed between the inner end and the outer end,
wherein the shaft includes one or more shaft sections, and wherein each shaft section includes an outer circumference, the outer circumference of each shaft section decreasing from the outer end to the inner end.

2. The modular wall of claim 1, wherein each shaft section further includes one or more ridges disposed around the outer circumference of each shaft section.

3. The modular wall of claim 1, wherein the capital includes at least one light source.

4. The modular wall of claim 3, wherein each light source is in electrical communication with an apparatus, and wherein the apparatus is configured to selectively illuminate the at least one light source.

5. The modular wall of claim 4, further including:
a database stored on a machine-readable memory of the apparatus,
wherein the database contains one or more preconfigured lighting arrangements, and
wherein, upon a selection of a lighting arrangement by a user, the apparatus illuminates one or more light sources in accordance with the selected lighting arrangement.

6. The modular wall of claim 1, wherein the capital is disc-shaped, having a diameter which is greater than a diameter of the outer end of the shaft.

7. The modular wall of claim 1, wherein the capital of the telescopic member is joined to the capital of at least one adjacent telescopic member.

8. The modular wall of claim 1, wherein the base and the unit are a unibody construction.

9. The modular wall of claim 1, wherein each unit is configured to be removably attached to other units via one or more grooves or protrusions.

10. A modular wall system, the system including:
one or more units, wherein each unit includes a telescopic member having an inner end and an outer end, the telescopic member including:
a base, located at the inner end;
a capital, located at the outer end,
wherein the capital includes at least one light source; and
a shaft disposed between the inner end and the outer end,
wherein the shaft includes one or more shaft sections, and wherein each shaft section includes an outer circumference, the outer circumference of each shaft section decreasing from the outer end to the inner end; and
an apparatus,
wherein the apparatus is in electrical communication with each of the at least one light source, and
wherein the apparatus is configured to selectively illuminate the at least one light source.

11. The modular wall system of claim 10, wherein each shaft section further includes one or more ridges disposed around the outer circumference of each shaft section.

12. The modular wall system of claim 10, further including:
a database stored on a machine-readable memory of the apparatus,
wherein the database contains one or more preconfigured lighting arrangements, and
wherein, upon a selection of a lighting arrangement by a user, the apparatus illuminates one or more light sources in accordance with the selected lighting arrangement.

13. The modular wall system of claim 10, wherein the capital is disc-shaped, having a diameter which is greater than a diameter of the outer end of the shaft

14. The modular wall system of claim 10, wherein the capital of the telescopic member, is joined to the capital of at least one adjacent telescopic member.

15. The modular wall system of claim 10, wherein the base and the unit are a unibody construction.

16. The modular wall system of claim 10, wherein each unit is configured to be removably attached to other units via one or more grooves or protrusions.
